(19) United States
(12) Patent Application Publication
(10) Pub. No.: US 2020/0232448 A1
(43) Pub. Date: Jul. 23, 2020

(54) LIQUID SUPPLY SYSTEM

(71) Applicant: EAGLE INDUSTRY CO., LTD., Tokyo (JP)

(72) Inventors: Kiyotaka FURUTA, Minato-ku, Tokyo (JP); Koichi MORI, Minato-ku, Tokyo (JP); Hiroshi TAKATA, Minato-ku, Tokyo (JP)

(21) Appl. No.: 16/482,737

(22) PCT Filed: Feb. 2, 2018
(86) PCT No.: PCT/JP2018/003638

§ 371 Date: Aug. 1, 2019

(30) Foreign Application Priority Data
Feb. 3, 2017 (JP) 2017019052

(51) Int. Cl. F04B 15/08; F04B 43/08; F25B 9/00

(52) U.S. Cl. CPC F04B 15/08; F04B 43/08; F05B 2210/11; F04B 2015/0824; F04B 2015/082; F25B 9/00

(57) ABSTRACT

A liquid supply system that can be cooled efficiently. The liquid supply system 10 includes a container having an inlet 131b and an outlet 131c for liquid and provided with pump chambers P1, P2 inside it, supply passages 131e, 131Xc through which the liquid flowing in from the inlet 131b is supplied to the pump chambers P1, P2, and a discharge passage 190 through which the liquid discharged from the pump chambers P1, P2 is brought to the outlet 131c. A thermal resistance layer 500 is provided on a surface 180, 181 of a wall that is in contact with the liquid in the pump chamber P1, P2. The thermal resistance layer is made of a material (e.g. PTFE) having a thermal conductivity lower than the material of the wall 180, 181.

### CROSS-REFERENCE TO RELATED APPLICATIONS

This application is a National Stage of International Application No. PCT/JP2018/003638, filed Feb. 2, 2018 (now WO 2018/143422), which claims priority to Japanese Application No. 2017-019052, filed Feb. 3, 2017. The entire disclosures of each of the above applications are incorporated herein by reference.

### FIELD

The present disclosure relates to a liquid supply system used to supply liquid.

### BACKGROUND

A liquid supply system using a bellows pump including pump chambers formed by bellows is known as a system used to cause a liquid to flow in a circulation fluid passage (see Patent Literature 1 in the citation list below). This system has two pump chambers arranged one above the other along the vertical direction. The bellows that forms each pump chamber is fixedly attached to a shaft that is driven by an actuator to move upward and downward, and the bellows expands and contracts with the upward and downward motion of the shaft.

The pump apparatus is housed in a vacuum container for heat insulation, above which the actuator is disposed. For the purpose of helping heat insulation, an inlet pipe for supplying liquid to the pump apparatus from outside and an outlet pipe for discharging liquid from the pump apparatus to outside may be connected to the pump apparatus at locations as remote as possible from the outside air. For this reason, the inlet pipe and the outlet pipe are arranged to enter into the vacuum container from above, extend to a location lower than the pump apparatus, then turn in a U-shape, and be connected to openings provided on the bottom of the pump apparatus. This shape of the pipes connected to the pump apparatus provides insulation against heat coming from outside. The bellows pump structured as above can be suitably used for the purpose of supplying a cryogenic liquid such as liquid nitrogen or liquid helium to an apparatus to be cooled, such as a superconducting device.

When a bellows pump assembled or maintained in an ordinary temperature environment is used to supply low temperature liquid, it is necessary to cool the components of the pump apparatus from the ordinary temperature to the temperature of the low temperature liquid. If the temperature of the components is high, the low temperature liquid will evaporate in a bellows chamber to be in a mixed state of gas and liquid, impairing the operation of the pump. One method of cooling the pump apparatus is causing low temperature liquid to flow in the pump apparatus to cause heat exchange between the components of the pump apparatus and the low temperature liquid, thereby gradually lowering the temperature of the components. In the process of this method, the low temperature liquid flowing into the pump apparatus from its bottom fills the interior of the pump chamber; specifically the liquid firstly fills the lower bellows pump chamber and then the upper bellows pump chamber, as the level of the low temperature liquid increases. However, cooling the bellows pump to an operable temperature by this cooling method takes a long time.

One reason for this is that when the level of the low temperature liquid in the pump apparatus is low, the contact area of the components of the pump and the low temperature liquid is small, and the efficiency of cooling is low in the early stage of the cooling process. Another reason is that when the temperature of the components of the pump is high, the low temperature liquid evaporates to create gas staying in the pump chambers, which blocks the entrance of the low temperature liquid. Moreover, since the two bellows pump chambers are arranged one (the first pump chamber) above the other (the second pump chamber), the liquid supplied into the pump apparatus flows out through the discharge port of the second (or lower) pump chamber, and the liquid level is slow to rise above the height of the discharge port of the second pump chamber. Therefore, if the first pump chamber is located above the discharge port of the second pump chamber, cooling of the first pump chamber takes a long time. In addition, the components of the pump are made of a metal material(s) having high rigidity in order to allow high discharge pressure, and when low temperature liquid comes in contact with the surface of the metal, which has high thermal conductivity, the surface of the metal is covered with gas produced by evaporation of the low temperature liquid. This phenomenon is called film boiling. The gas layer produced on the metal surface in this way functions as a heat insulation layer to block heat transfer between the low temperature liquid and the components of the pump. Patent Literature 2 describes coating a sliding portion of a pump chamber with polytetrafluoroethylene (PTFE) to reduce frictional resistance (or to increase sliding performance).

### CITATION LIST

### Patent Literature

[PTL 1] WO 2016/006648

[PTL 2] Japanese Patent Application Laid-Open No. 2012-193664

### SUMMARY

### Technical Problem

An object of the present disclosure is to provide a liquid supply system that can be cooled efficiently.

### Solution to Problem

To achieve the above object, the following features are adopted.

An aspect of the present disclosure is a liquid supply system comprises: a container having an inlet and an outlet for liquid and provided with a pump chamber inside it; a supply passage through which the liquid flowing in from the inlet is supplied to the pump chamber; and a discharge passage through which the liquid discharged from the pump chamber is brought to the outlet, wherein a thermal resistance layer is formed on a surface of a wall in the liquid supply system that is in contact with the liquid, the thermal resistance layer being made of a material having a lower thermal conductivity than the material of the wall.

The heat transfer rate between the low temperature liquid and the portion of the component of the system on which the thermal resistance layer is provided is lower in the above configured liquid supply system than that in the case where the low temperature liquid and the component of the system are in direct contact with each other. This results in a large temperature gradient from the surface of the thermal resistance layer that is in contact with liquid to the interior of the component of the system when there is a large temperature difference between the component of the liquid supply system and the liquid, which may occur when, for example, low temperature liquid is supplied into the liquid supply system in an ordinary temperature environment for the purpose of cooling. In other words, this results in a large temperature difference between the surface of the thermal resistance layer in contact with liquid and the interface between the thermal resistance layer and the component of the system. In consequence, even when the temperature inside the component is relatively high (e.g. around room temperature), the temperature of the surface of the thermal resistance layer in contact with liquid is relatively low (e.g. near the temperature of the low temperature liquid). Thus, the boiling of the low temperature liquid on the surface of the thermal resistance layer progresses moderately. This makes the size of gas bubbles of boiled liquid generated on the surface of the thermal resistance layer small. This prevents a gas layer made of large bubbles from being generated on the surface of the thermal resistance layer. Since a gas layer having a heat insulation effect tends not to be produced on the surface of the thermal resistance layer, heat transfer between the liquid and the component of the system tends not to be decreased by such a gas layer. This makes heat exchange between the low temperature liquid and the component progress efficiently. In consequence, the liquid supply system can be cooled efficiently by supplying low temperature liquid. Therefore, it is possible to reduce the time taken to cool the liquid supply system in an ordinary temperature environment in order to make it operable. This prevents an increase in the man-hour in setting-up and maintenance of the system. In addition, the consumption of low temperature liquid in the cooling process can be reduced.

The thermal resistance layer may be made of a coating film. The thermal resistance layer as such can be formed as a simple layer.

The coating film may include a plurality of film members arranged adjacent to one another. If the coating film is made of a plurality of film members instead of a single film, a high stress is prevented from being caused in the coating film by thermal compression or other reasons. Thus, the coating film is prevented from falling off from the wall surface.

The thermal resistance layer may be provided on an inner surface of the wall of the pump chamber that is in contact with the liquid. The boiling of low temperature liquid progresses moderately on the inner surface of the wall of the pump chamber on which the thermal resistance layer is provided. Thus, large gas bubbles of boiled low temperature liquid tend not to be produced on the inner surface of the wall of the pump chamber. This prevents a gas layer from being produced on that surface. Thus, heat exchange between the low temperature liquid and the component of the pump chamber progresses efficiently, resulting in efficient cooling of the pump chamber by supplying the low temperature liquid into the pump chamber. This eliminates a situation in which gas of the low temperature liquid stays in the pump chamber early and reduces the time taken to cool the liquid supply system to make it operable.

The thermal resistance layer may be provided on an inner surface of the wall the supply passage and an inner surface of the discharge passage. This improves the efficiency of cooling of the components of the liquid supply system.

The wall on which the thermal resistance layer is provided may be made of a metal material, and the thermal resistance layer may comprise a PTFE film having a thickness of 0.2 millimeter. Our experiments revealed that providing a thermal resistance layer made of a PTFE film having a thickness of 0.2 millimeter gives a cooling speed twice higher than that in the case where no thermal resistance layer is provided.

Another aspect of the present disclosure is a liquid supply system having bellows pumps. Specifically, the liquid supply system may comprise: a shaft member that moves vertically upward and downward in the container; and a first bellows and a second bellows disposed one above the other along the vertical direction, each of which expands and contracts with upward and downward motion of the shaft member; wherein the pump chamber may include a first pump chamber formed by a space surrounding the outer circumference of the first bellows and a second pump chamber formed by a space surrounding the outer circumference of the second bellows, and the thermal resistance layer may be provided on an inner surface of the wall of the space surrounding the outer circumference of the first bellows in the first pump chamber and an inner surface of the wall of the space surrounding the outer circumference of the second bellows in the second pump chamber.

Since the low temperature liquid is boiled moderately on the inner surface of the first and second pump chambers, a gas layer having a heat insulation effect is prevented from being produced on the inner surface. In consequence, cooling of the first and second pump chambers by low temperature liquid can be performed efficiently. This reduces the time taken to cool the liquid supply system in order to make it operable.

The above-described features may be adopted in any feasible combination.

### Advantageous Effects of the Disclosure

As above, the liquid supply system according to the present disclosure can be cooled efficiently.

### DRAWINGS

FIG. 1 is a diagram illustrating the general configuration of a liquid supply system in an embodiment.

FIGS. 2A and 2B are diagrams illustrating the effect of a thermal resistance layer in the embodiment.

FIGS. 3A and 3B are diagrams illustrating examples of the configuration of the thermal resistance layer in the embodiment.

### DETAILED DESCRIPTION

In the following, modes for carrying out the present disclosure will be described specifically on the basis of a specific embodiment with reference to the drawings. The dimensions, materials, shapes, relative arrangements, and other features of the components that will be described in connection with the embodiment are not intended to limit the technical scope of the present disclosure only to them, unless particularly stated.

### Embodiment

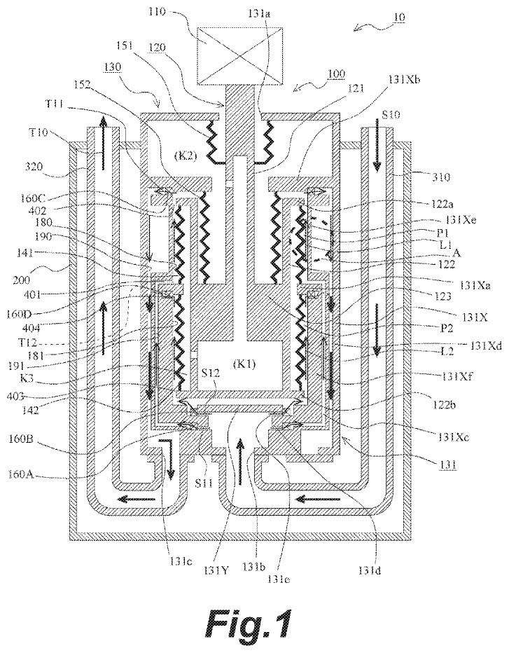

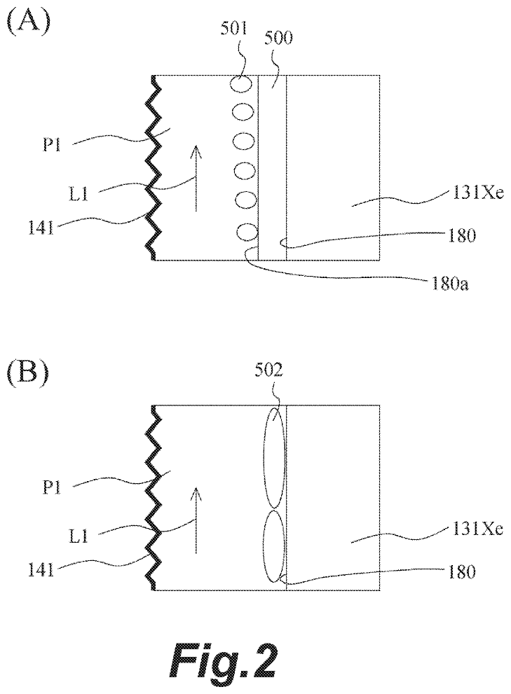

A liquid supply system in an embodiment will be described with reference to FIGS. 1 and 2. The liquid supply system is suitably used for the purpose of, for example, maintaining a superconducting device in an ultra-low temperature state. Superconducting devices require perpetual cooling of components such as superconducting coils. Thus, a device to be cooled including a superconducting coil and other components is perpetually cooled by continuous supply of a cryogenic liquid (such as liquid nitrogen or liquid helium) to the cooled device. Specifically, a circulation fluid passage passing through the cooled device is provided, and the liquid supply system is connected to the circulation fluid passage to cause the cryogenic liquid to circulate, thereby enabling perpetual cooling of the cooled device.

### <Overall Configuration of the Liquid Supply System>

FIG. 1 is a schematic diagram illustrating the overall configuration of the liquid supply system, where the overall configuration of the liquid supply system is illustrated in a cross section. The liquid supply system 10 includes a main unit of the liquid supply system (which will be referred to as the “main system unit 100” hereinafter), a vacuum container 200 in which the main system unit 100 is housed, and pipes (including an inlet pipe 310 and an outlet pipe 320). The inlet pipe 310 and the outlet pipe 320 both extend into the interior of the vacuum container 200 from outside the vacuum container 200 and are connected to the main system unit 100. The interior of the vacuum container 200 is a hermetically sealed space. The interior space of the vacuum container 200 outside the main system unit 100, the inlet pipe 310, and the outlet pipe 320 is kept in a vacuum state. Thus, this space provides heat insulation. The liquid supply system 10 is normally installed on a horizontal surface. In the installed state, the upward direction of the liquid supply system 10 in FIG. 1 is the vertically upward direction and the downward direction in FIG. 1 is the vertically downward direction.

The main system unit 100 includes a linear actuator 110 serving as a driving source, a shaft member 120 that is moved in vertically upward and downward directions by the linear actuator 110, and a container 130. The linear actuator 110 is fixed on something suitable, which may be the container 130 or something that is not shown in the drawings. The container 130 includes a casing 131. The shaft member 120 extends from outside the container 130 into the inside through an opening 131a provided in the ceiling portion of the casing 131. The casing 131 has an inlet 131b and an outlet 131c for liquid on its bottom. The inlet pipe 310 is connected to the inlet 131b and the outlet pipe 320 is connected to the outlet 131c.

Inside the casing 131 are provided a plurality of structural components that compart the interior space into a plurality of spaces, which constitute a plurality of pump chambers, passages for liquid, and vacuum chambers providing heat insulation. In the following, the structure inside the casing 131 will be described in further detail.

The shaft member 120 has a main shaft portion 121 having a cavity in it, a cylindrical portion 122 surrounding the outer circumference of the main shaft portion 121, and a connecting portion 123 that connects the main shaft portion 121 and the cylindrical portion 122. The cylindrical portion 122 is provided with an upper outward flange 122a at its upper end and a lower outward flange 122b at its lower end.

The casing 131 has a substantially cylindrical body portion 131X and a bottom plate 131Y. The body portion 131X has a first inward flange 131Xa provided near its vertical center and a second inward flange 131Xb provided on its upper portion.

Inside the body portion 131X, there are a plurality of first fluid passages 131Xc that extend in the axial direction below the first inward flange 131Xa and are spaced apart from one another along the circumferential direction. Inside the body portion 131X, there also is a second fluid passage 131Xd, which is an axially extending cylindrical space provided radially outside the region in which the first fluid passages 131Xc are provided. The bottom portion of the casing 131 is provided with a fluid passage 131d that extends circumferentially and radially outwardly to join to the first fluid passages 131Xc. The bottom plate 131Y of the casing 131 is provided with a fluid passage 131e that extends circumferentially and radially outwardly. These fluid passages 131d and 131e extend uniformly all along the circumferential direction to allow liquid to flow radially outwardly in all directions, namely 360 degrees about the center axis.

Inside the container 130, there are provided a first bellows 141 and a second bellows 142, which expand and contract with the up and down motion of the shaft member 120. The first bellows 141 and the second bellows 142 are arranged one above the other along the vertical direction. The upper end of the first bellows 141 is fixedly attached to the upper outward flange 122a of the cylindrical portion 122 of the shaft member 120 and the lower end of the first bellows 141 is fixedly attached to the first inward flange 131Xa of the casing 131. The upper end of the second bellows 142 is fixedly attached to the first inward flange 131Xa of the casing 131 and the lower end of the second bellows 142 is fixedly attached to the lower outward flange 122b of the cylindrical portion 122 of the shaft member 120. The space surrounding the outer circumference of the first bellows 141 forms a first pump chamber P1 and the space surrounding the outer circumference of the second bellows 142 forms a second pump chamber P2.

Inside the container 130, there also are provided a third bellows 151 and a fourth bellows 152, which expand and contract with the up and down motion of the shaft member 120. The upper end of the third bellows 151 is fixedly attached to the ceiling portion of the casing 131 and the lower end of the third bellows 151 is fixedly attached to the shaft member 120. Thus, the opening 131a of the casing 131 is closed. The upper end of the fourth bellows 152 is fixedly attached to the second inward flange 131Xb provided on the casing 131 and the lower end of the fourth bellows 152 is fixedly attached to the connecting portion 123 of the shaft member 120. A first space K1 is formed by the cavity in the main shaft portion 121 of the shaft member 120. A second space K2 is formed outside the third bellows 151 and inside the fourth bellows 152. A third space K3 is formed inside the first bellows 141 and the second bellows 142 and outside the cylindrical portion 122. The first space K1, the second space K2, and the third space K3 are in communication with each other. The space constituted by the first to third spaces K1, K2, and K3 is hermetically sealed. This space is kept in a vacuum condition to provide heat insulation.

There are four check valves 160 including a first check valve 160A, a second check valve 160B, a third check valve 160C, and a fourth check valve 160D, which are provided at different locations inside the container 130. The first check valve 160A and the second check valve 160B are disposed on the opposite side (lower side) of the linear actuator 110 with respect to the first pump chamber P1 and the second pump chamber P2. The third check valve 160C and the fourth check valve 160D are arranged above the first check valve 160A and the second check valve 160B.

The first check valve 160A and the third check valve 160C are provided in the fluid passage passing through the first pump chamber P1. The first check valve 160A and the third check valve 160C block backflow of liquid pumped by the pumping effect of the first pump chamber P1. Specifically, the first check valve 160A is provided on the upstream side of the first pump chamber P1 and the third check valve 160C is provided on the downstream side of the first pump chamber P1. The first check valve 160A is provided in the fluid passage 131d provided in the bottom portion of the casing 131. The third check valve 160C is provided in the fluid passage formed in the vicinity of the second inward flange 131Xb provided on the casing 131.

The second check valve 160B and the fourth check valve 160D are provided in the fluid passage passing through the second pump chamber P2. The second check valve 160B and the fourth check valve 160D block backflow of liquid pumped by the pumping effect of the second pump chamber P2. Specifically, the second check valve 160B is provided on the upstream side of the second pump chamber P2 and the fourth check valve 160D is provided on the downstream side of the second pump chamber P2. The second check valve 160B is provided in the fluid passage 131e provided in the bottom plate 131Y of the casing 131. The fourth check valve 160D is provided in the fluid passage formed in the vicinity of the first inward flange 131Xa of the casing 131.

### <Description of the Overall Operation of the Liquid Supply System>

The overall operation of the liquid supply system will be described. When the shaft member 120 is lowered by the linear actuator 110, the first bellows 141 contracts and the second bellows 142 expands. Consequently, the fluid pressure in the first pump chamber P1 decreases. Then, the first check valve 160A is opened and the third check valve 160C is closed. In consequence, liquid supplied from outside the liquid supply system 10 through the inlet pipe 310 (indicated by arrow S10) is taken into the interior of the container 130 through the inlet 131b and passes through the first check valve 160A (indicated by arrow S11). Then, the liquid having passed through the first check valve 160A is pumped into the first pump chamber P1 through the first fluid passages 131Xc in the body portion 131X of the casing 131. On the other hand, the fluid pressure in the second pump chamber P2 increases. Then, the second check valve 160B is closed and the fourth check valve 160D is opened. In consequence, the liquid in the second pump chamber P2 is pumped into the second fluid passage 131Xd provided in the body portion 131X through the fourth check valve 160D (see arrow T12). Then, the liquid passes through the outlet 131c and is brought to the outside of the liquid supply system 10 through the outlet pipe 320.

When the shaft member 120 is raised by the linear actuator 110, the first bellows 141 expands and the second bellows 142 contracts. Consequently, the fluid pressure in the first pump chamber P1 increases. Then, the first check valve 160A is closed and the third check valve 160C is opened. In consequence, the liquid in the first pump chamber P1 is pumped into the second fluid passage 131Xd provided in the body portion 131X through the third check valve 160C (indicated by arrow T11). Then, the liquid passes through the outlet 131c and is brought to the outside of the liquid supply system 10 through the outlet pipe 320. On the other hand, the fluid pressure in the second pump chamber P2 decreases. Then, the second check valve 160B is opened and the fourth check valve 160D is closed. In consequence, liquid supplied from outside the liquid supply system 10 through the inlet pipe 310 (indicated by arrow S10) is taken into the interior of the container 130 through the inlet 131b and passes through the second check valve 160B (indicated by arrow S12). Then, the liquid having passed through the second check valve 160B is pumped into the second pump chamber P2.

As above, the liquid supply system 10 can cause liquid to flow from the inlet pipe 310 to the outlet pipe 320 both when the shaft member 120 moves downward and when the shaft member 120 moves upward. Hence, the phenomenon called pulsation can be reduced.

### <Cooling of the Liquid Supply System>

When the liquid supply system 10 is used for circulation of a cryogenic liquid such as liquid nitrogen or liquid helium, it is necessary, before operation, to cool the liquid supply system 10 in an ordinary temperature environment to a temperature as low as a low temperature liquid used as a working liquid. The liquid used to cool the system is same as the low temperature liquid that is caused to flow by the liquid supply system when it is operating. The liquid used to cool the system may be different from the low temperature liquid that is caused to flow by the liquid supply system when it is operating.

Cooling of the system is performed by supplying low temperature liquid through the inlet pipe 310 to let heat exchange between the components of the liquid supply system 10 including the casing 131 and the low temperature liquid occur thereby gradually lowering the temperature of the components. Since the inlet 131b and the outlet 131c are provided on the bottom of the container 100, the low temperature liquid supplied in the cooling process gradually fills the interior of the system, as the level of the low temperature liquid rises. Specifically, the low temperature liquid fills the second pump chamber P2 firstly and then the first pump chamber P1. As the level of the low temperature liquid increases, components that exchange heat with the low temperature liquid increase. Thus, cooling progresses from the lower portion to the upper portion of the system.

### <Thermal Resistance Layer>

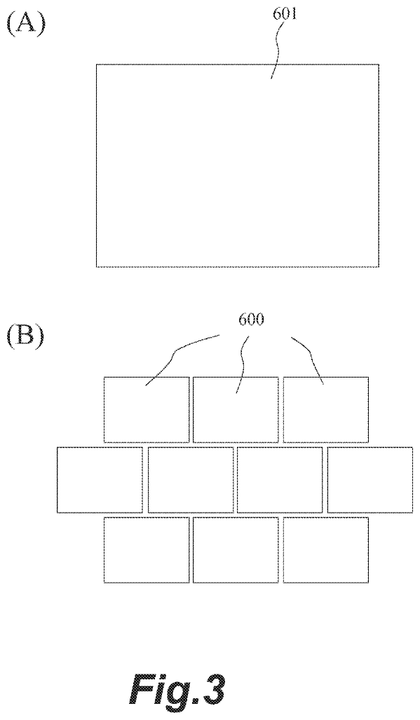

A thermal resistance layer will be described with reference to FIGS. 1 to 3. FIG. 2A is an enlarged view of the portion indicated by the broken circle A in FIG. 1. FIG. 2B is a diagram illustrating the portion same as FIG. 2A in a comparative configuration where the thermal resistance layer is not provided. For the sake of simplicity, FIG. 2A illustrates only a portion of the first bellows 141 and a portion of a wall 131Xe of the first pump chamber P1. FIGS. 3A and 3B illustrate a method of forming the thermal resistance layer.

The first pump chamber P1 is a space formed between the outer circumferential surface of the first bellows 141 and the inner surface 180 of the wall 131Xe opposed to the first bellows 141. The wall 131Xe is in contact with the liquid flowing in the first pump chamber P1. The wall 131Xe is a part of the casing 131 and exchanges heat with structural components constituting the main system unit 100. As illustrated in FIG. 2A, a thermal resistance layer 500 is provided on the surface 180 of the wall 131Xe. The wall is made of a metal material. The thermal resistance layer 500 is formed by covering the wall surface 180 with a PTFE film, which has a thermal conductivity lower than metal material. The PTFE film has a thickness of 0.2 millimeter. The thermal resistance layer 500 may be adhered to a structural component of the main system unit 100 by an adhesive or fixed to the structural component of the main system unit 100 by an elastic force of an elastic member.

The second pump chamber P2 is also provided with a similar thermal resistance layer. Specifically, a PTFE coating film is provided as a thermal resistance layer on the surface 181 of the wall 131Xf opposed to the second bellows 142.

The thermal resistant layer 500 made of a PTFE coating film is formed by arranging a plurality of relatively small rectangular film members 600 made of PTFE adjacent to one another like tiles on the inner surface of the wall, as illustrated in FIG. 3B. This configuration prevents a great stress from being caused by thermal compression or other reasons, thereby preventing the coating film from falling off from the inner surface of the wall. Alternatively, the thermal resistance layer 500 may be formed using a single film member 601 of PTFE, as illustrated in FIG. 3A. In the case where the coating film is formed by arranging a plurality of film members adjacent to one another, the shape of each film member is not limited to a rectangular shape like that shown in FIG. 3B.

### <Advantages of the Liquid Supply System>

FIG. 2B illustrates a case where a thermal resistance layer made of a PTFE coating film is not provided on the inner surface of the wall made of a metal material. Since metals have high thermal conductivity, if low temperature liquid comes in contact with the metal wall at an ordinary temperature in the cooling process, the low temperature liquid is boiled suddenly on the inner surface of the wall to generate large gas bubbles 502. Thus, a gas layer is formed on the inner surface of the wall. If the bubbles move and a portion of the inner surface from which the gas layer has left comes in contact with the liquid again, a large bubble 502 is generated again, because the heat inside the wall is quickly conducted to the metal surface due to its high thermal conductivity. Thus, a gas layer is always formed on the inner surface of the wall. This gas layer has a heat insulation effect to prevent heat transfer between the low temperature liquid and the wall. In consequence, cooling of structural components such as walls of the system made of metal materials takes a long time.

As illustrated in FIG. 2A, the system has a coating layer made of PTFE as a thermal resistance layer 500 provided on the inner surface 180 of the wall 131Xe made of a metal. The thermal conductivity of PTFE is lower than those of metals, resulting in a larger temperature gradient from the surface 180a of the thermal resistance layer 500 that is in contact with the liquid to the interior of the wall 131Xe made of a metal material. This means that the PTFE layer conducts heat of the wall 131Xe to the surface in contact with liquid gradually or more moderately than the metal. Thus, even when the temperature of the wall 131Xe is relatively high (e.g. around room temperature), the temperature of the surface 180a of the thermal resistance layer 500 that is in contact with liquid is relatively low (e.g. near the temperature of the low temperature liquid). In consequence, heat exchange between the wall 131Xe and the low temperature liquid progresses gradually and the boiling of the low temperature liquid on the surface 180a of the thermal resistance layer 500 progresses moderately. Thus, the bubbles 501 of gas generated on the surface 180a of the thermal resistance layer 500 by the boiling of liquid are small in size.

This prevents a gas layer of large bubbles 502 that is generated in the case where liquid is in direct contact with the metal surface as illustrated in FIG. 2B from being formed. Since a gas layer having a heat insulation effect tends not to be generated on the surface 180a of the thermal resistance layer 500, heat transfer between the liquid and structural components tends not to be decreased by such a gas layer. Hence, heat exchange between the low temperature liquid and structural components progresses efficiently. In consequence, the system can be cooled efficiently by supplying low temperature liquid to it. This can lead to a reduction in time taken to cool the liquid supply system in an ordinary temperature environment in order to make it operable, thereby preventing an increase in the man-hour in setting-up and maintenance of the system. In addition, the consumption of low temperature liquid in the cooling process can be reduced. A similar thermal resistance layer is also provided in the second pump chamber P2, which prevents a gas layer from being generated on its inner surface of the wall, enabling efficient heat exchange between the low temperature liquid and structural components.

Others

While in the above described embodiment a thermal resistance layer is provided on the inner surface 180 of the wall 131Xe that defines the first pump chamber P1 and on the inner surface 181 of the wall 131Xf that defines the second pump chamber P2, a thermal resistance layer may be provided on any other portion that exchanges heat with structural components of the main system unit 100 and is in contact with low temperature liquid. For example, a thermal resistance layer may be provided also on the inner surface of the wall of a fluid passage through which liquid is supplied to a pump chamber. Specifically, a PTFE coating film as a thermal resistance layer may be provided on an inner surface of the wall of a supply passage joined with an inlet 401 of the first pump chamber P1, an inner surface of the wall of a discharge passage joined with an outlet 402 of the first pump chamber P1, an inner surface of the wall of a supply passage joined with an inlet 403 of the second pump chamber P2, or/and an inner surface of the wall of a discharge passage joined with an outlet 404 of the second pump chamber P2. While a PTFE film is used as the thermal resistance layer in this embodiment, the material of the thermal resistance layer is not limited to PTFE. The material of the thermal resistance layer may be any material that has a lower thermal conductivity than the material (e.g. a metal) of the inner surface of the wall of the pump chamber or other components to be cooled.

While we have described a case where the present disclosure is applied to a liquid supply system provided with a bellows pump including two pump chambers formed around the outer circumference of bellows that are arranged one above the other along the vertical direction (or the direction of expansion and contraction of the bellows), liquid supply systems to which the present disclosure can be applied are not limited to this type. The present disclosure can be applied to pumps in general that take in and discharge liquid, and advantageous effects same as the above-described embodiment can be achieved by providing a thermal resistance layer on a portion of an inner surface of a pump chamber in contact with liquid that exchanges heat with structural components of the pump chamber or the main unit of a liquid supply system.

The interior space of the vacuum container 200 outside the main system unit 100, the intake pipe 310, and the outlet pipe 320 is kept in a vacuum state to provide heat insulation. Moreover, the hermetically sealed space constituted by the first to third spaces K1, K2, and K3 is kept in a vacuum state to provide heat insulation. Alternatively, these spaces may also be supplied with cryogenic liquid to keep the temperature of liquid flowing in a circulation fluid passage low.

### REFERENCE SIGNS LIST

10: liquid supply system
100: main system unit
110: linear actuator
120: shaft member
121: main shaft portion
122: cylindrical portion
122a: upper outward flange
122b: lower outward flange
123: connecting portion
130: container
131: casing
131a: opening
131b: inlet
131c: outlet
131d: fluid passage
131e: fluid passage
131X: body portion
131Xa: first inward flange
131Xb: second inward flange
131Xc: first fluid passage
131Xd: second fluid passage
131Xe: wall
131Xf: wall
131Y: bottom plate
141: first bellows
142: second bellows
151: third bellows
152: fourth bellows
160: check valve
160A: first check valve
1606: second check valve
160C: third check valve
160D: fourth check valve
180: inner surface
180a: surface of thermal resistance layer
181: inner surface
190: inner surface
200: vacuum container
310: inlet pipe
320: outlet pipe
401: inlet of first pump chamber
402: outlet of first pump chamber
403: inlet of second pump chamber
404: outlet of second pump chamber
500: thermal resistance layer
501: bubble
502: bubble
600: film
601: film
P1: first pump chamber
P2: second pump chamber

1. A liquid supply system comprising:
a container having an inlet and an outlet for liquid and provided with a pump chamber inside it;
a supply passage through which the liquid flowing in from the inlet is supplied to the pump chamber; and
a discharge passage through which the liquid discharged from the pump chamber is brought to the outlet,
wherein a thermal resistance layer is formed on a surface of a wall in the liquid supply system that is in contact with the liquid, the thermal resistance layer being made of a material having a lower thermal conductivity than the material of the wall.

2. The liquid supply system according to claim 1, wherein the thermal resistance layer comprises a coating film.

3. The liquid supply system according to claim 2, wherein the coating film comprises a plurality of film members arranged adjacent to one another.

4. The liquid supply system according to claim 1, wherein the thermal resistance layer is provided on an inner surface of the wall of the pump chamber that is in contact with the liquid.

5. The liquid supply system according to claim 1, wherein the thermal resistance layer is provided on an inner surface of the wall of the supply passage and an inner surface of the discharge passage.

6. The liquid supply system according claim 1, wherein the wall on which the thermal resistance layer is provided is made of a metal material, and
the thermal resistance layer comprises a PTFE film having a thickness of 0.2 millimeter.

7. The liquid supply system according to claim 1, comprising:
a shaft member that moves vertically upward and downward in the container; and
a first bellows and a second bellows disposed one above the other along the vertical direction, each of which expands and contracts with upward and downward motion of the shaft member;
wherein the pump chamber includes a first pump chamber formed by a space surrounding the outer circumference of the first bellows and a second pump chamber formed by a space surrounding the outer circumference of the second bellows, and
the thermal resistance layer is provided on an inner surface of the wall of the space surrounding the outer circumference of the first bellows in the first pump chamber and an inner surface of the wall of the space surrounding the outer circumference of the second bellows in the second pump chamber.
